(19) United States
(12) Patent Application Publication
(10) Pub. No.: US 2011/0314833 A1
(43) Pub. Date: Dec. 29, 2011

(54) ADDITIVE INJECTION SYSTEM FOR USE WITH A TURBINE ENGINE AND METHODS OF ASSEMBLING SAME

(76) Inventor: Richard A. Symonds, Longwood, FL (US)

(21) Appl. No.: 12/826,212

(22) Filed: Jun. 29, 2010

(51) Int. Cl. F02C 3/30; B23P 15/04

(52) U.S. Cl. 60/775; 29/889.2

(57) ABSTRACT

A method for assembling an additive injection system for use with a turbine engine includes coupling an atomizing air connection to a fuel nozzle assembly and coupling an additive source to the atomizing air connection.

### BACKGROUND OF THE INVENTION

The embodiments described herein relate generally to rotating machines and, more particularly, to turbine engine fuel nozzle assemblies.

At least some known turbine engines ignite a fuel-air mixture in a combustor to generate combustion gases that are channeled towards a turbine via a hot gas path. Known combustor assemblies include fuel nozzles that channel fuel to a combustion region of the combustor. The turbine converts thermal energy of the combustion gas stream to mechanical energy used to rotate a turbine shaft. Output of the turbine may be used to power a machine, for example, an electric generator, a compressor, or a pump.

In at least some known turbine engines, during operation, combustion of fuel and air may introduce impurities into the combustion gas stream that may adhere to portions of the combustor and to portions of the turbine engine downstream from the combustion region. Over time, such impurities may induce corrosive effects on such portions. Also, such combustion may facilitate undesired combustion byproduct formation. As a result, in at least some known turbine engines, an inhibitor may be injected into the combustion gas stream to facilitate a reduction in impurity-induced corrosion and/or undesired combustion byproduct formation. However, the additional hardware necessary to control inhibitor concentration and to inject the inhibitor increases the cost for the turbine engines to a point that the possible benefits from such injection may be outweighed by the costs. Moreover, in many known turbine engines, physical space restrictions limit access to route and install such additional hardware and to limit locating additional wall and casing penetrations.

### BRIEF SUMMARY OF THE INVENTION

In one aspect, a method for assembling an additive injection system for use with a turbine engine includes coupling an atomizing air connection to fuel nozzle assembly and coupling an additive source to the atomizing air connection.

In a further aspect, an additive injection system includes an atomizing air connection and an additive source coupled in flow communication with the atomizing air connection.

In another aspect, a turbine engine includes at least one combustor. The engine also includes at least one fuel nozzle assembly coupled in flow communication with the at least one combustor. The engine further includes an atomizing air connection coupled to the at least one fuel nozzle assembly. The engine also includes an additive source coupled in flow communication with the atomizing air connection.

### BRIEF DESCRIPTION OF THE DRAWINGS

The embodiments described herein may be better understood by referring to the following description in conjunction with the accompanying drawings.

FIG. 1 is schematic diagram of an exemplary turbine engine;

FIG. 2 is a schematic diagram of an exemplary additive injection system that may be used with the turbine engine shown in FIG. 1; and

FIG. 3 is a flow chart illustrating an exemplary method of assembling the additive injection systems shown in FIG. 2.

### DETAILED DESCRIPTION OF THE INVENTION

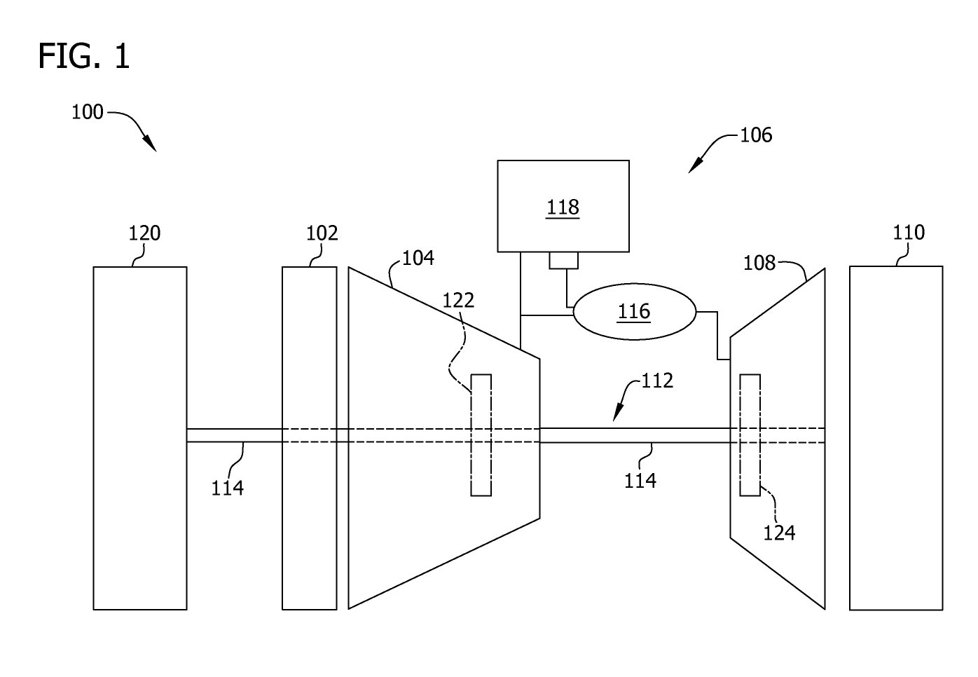

FIG. 1 is a schematic view of an exemplary turbine engine, that is, a gas turbine engine 100. In the exemplary embodiment, gas turbine engine 100 includes an air intake section 102. Gas turbine engine 100 also includes a compressor section 104 that is coupled downstream from, and in flow communication with, intake section 102. A combustor section 106 is coupled downstream from, and in flow communication with, compressor section 104, and a turbine section 108 is coupled downstream from, and in flow communication with, combustor section 106. Gas turbine engine 100 further includes an exhaust section 110 that is coupled downstream from, and in flow communication with, turbine section 108. Moreover, in the exemplary embodiment, turbine section 108 is coupled to compressor section 104 via a rotor assembly 112 that includes a drive shaft 114.

Moreover, in the exemplary embodiment, combustor section 106 includes at least one combustor 116 (only one shown in FIG. 1). More specifically, combustor section 106 is coupled to compressor section 104 such that combustor 116 is coupled in flow communication with compressor section 104. Alternatively, combustor section 106 includes a plurality of combustors 116. Combustor section 106 also includes at least one fuel nozzle assembly 118, wherein each combustor 116 is also coupled in flow communication with at least one fuel nozzle assembly 118. Further, in the exemplary embodiment, turbine section 108 and compressor section 104 are rotatably coupled to a load 120 via drive shaft 114. For example, load 120 may include, but is not limited to only including, an electrical generator and/or a mechanical drive application, e.g., a pump. Moreover, load 120 is positioned on a compressor-side of turbine engine 100. Alternatively, load 120 is positioned on a turbine-side of turbine engine 100. In the exemplary embodiment, compressor section 104 includes at least one compressor blade 122. Also, in the exemplary embodiment, turbine section 108 includes at least one turbine blade, or bucket 124. Each compressor blade 122 and each turbine bucket 124 are coupled to rotor assembly 112.

In operation, air intake section 102 channels air towards compressor section 104. Compressor section 104 compresses inlet air via compressor blades 122 to higher pressures and temperatures prior to discharging compressed air towards combustor section 106. The compressed air is mixed with fuel and ignited to generate combustion gases that are channeled towards turbine section 108. Specifically, fuel is channeled to fuel nozzle assembly 118, wherein the fuel is mixed and ignited within combustors 116. Also, specifically, a majority of compressed air is channeled towards combustors 116 to facilitate combustion of the fuel. Further, specifically, in the exemplary embodiment, at least a portion of compressed air is channeled to fuel nozzle assembly 118 for atomization purposes. Alternatively, substantially all air discharged from compressor section 104 is channeled towards combustors 116 and substantially no air is channeled towards fuel nozzle assembly 118.

Also, in operation, combustion gases generated within combustors 116 are channeled downstream towards turbine section 108. After impinging turbine buckets 124, thermal energy in the combustion gases is converted to mechanical rotational energy used to rotatably drive rotor assembly 112. Turbine section 108 drives compressor section 104 and/or load 120 via drive shaft 114, and exhaust gases are discharged through exhaust section 110 to ambient atmosphere. Alternatively, at least a portion of the exhaust gases are channeled to at least one of a heat recovery steam generator (HRSG), and any other energy recovery device and any industrial processes suitable for using the exhaust gases and the heat energy therein.

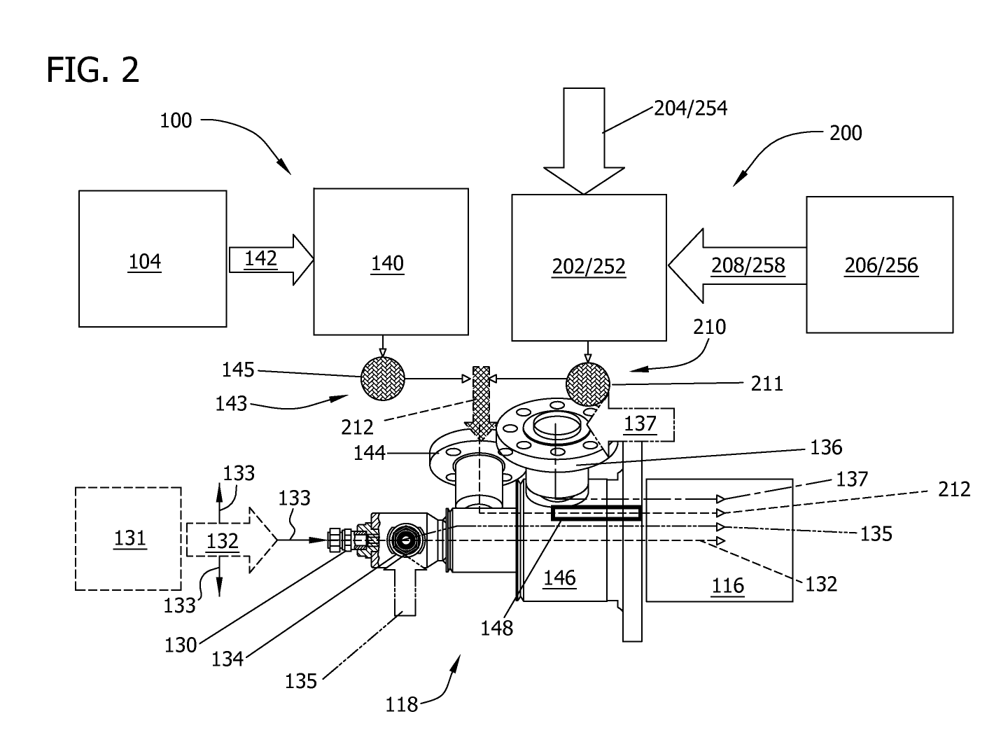

FIG. 2 is a schematic diagram of an exemplary additive injection system 200 that may be used with gas turbine engine 100 (shown in FIG. 1). In the exemplary embodiment, injection system 200 is coupled in flow communication with fuel nozzle assembly 118. Moreover, in the exemplary embodiment, a liquid fuel connection 130 is coupled in flow communication with at least one liquid fuel source 131 to enable liquid fuel to be selectively channeled to assembly 118 as indicated by flow arrows 132 in FIG. 2. Further, in the exemplary embodiment, liquid fuel source 131 is coupled to a plurality of fuel nozzle assemblies 118 (only one shown) via associated liquid fuel connections 130 (only one shown) and a plurality of liquid fuel headers 133 coupled in flow communication with fuel source 131. Alternatively, connections 130 are coupled to fuel headers 133 via any fuel conduit configuration and orientation that enables operation of gas turbine engine 100 as described herein including, but not limited to, a ring manifold (not shown).

In the exemplary embodiment, the fuel supplied from source 131 is a carbonaceous liquid such as, but not limited to, number 2 fuel oil. Alternatively, the fuel may be any liquid fuel that enables operation of additive injection system 200 and gas turbine engine 100 as described herein including, but not limited to, distillate and/or residual oils. Also, alternatively, fuel connection 130 may be configured to channel a gaseous fuel, wherein the fuel may be any gaseous fuel that enables operation of additive injection system 200 and gas turbine engine 100 as described herein including, but not limited to, natural gas and syngas.

Moreover, in the exemplary embodiment, at least one water injection connection 134 is coupled in flow communication with at least one pressurized water source (not shown) to enable pressurized water to be selectively channeled to assembly 118 as illustrated in FIG. 2 by flow arrows 135. In the exemplary embodiment, the water channeled from the water source is demineralized water that is used for emissions control, for example, control of nitrogen oxides (NO_{X}). Alternatively, any liquid that enables operation of gas turbine engine 100 as described herein may be used. Also, alternatively, fuel nozzle assembly 118 has no water injection connection 136.

Furthermore, in the exemplary embodiment, a gaseous fuel connection 136 is coupled in flow communication with at least one gaseous fuel source (not shown) to enable gaseous fuel to be selectively channeled to assembly 118 as illustrated in FIG. 2 by gaseous fuel flow arrows 137. In the exemplary embodiment, the fuel is a carbonaceous gas such as, but not limited to, a natural gas. Alternatively, the fuel supplied to assembly 118 may be any gaseous fuel that enables operation of gas turbine engine 100 as described herein including, but not limited to, a syngas. Also, alternatively, fuel nozzle assembly 118 includes no gaseous fuel connection 138 and no gaseous fuels are used.

Moreover, in the exemplary embodiment, fuel nozzle assembly 118 is coupled in flow communication to an atomizing air source 140 that receives compressed air from compressor section 104 as illustrated in FIG. 2 by compressed air flow arrow 142. Alternatively, source 140 receives compressed air from at least one independent source such as, but not limited to, an atomizing air tank and/or an auxiliary industrial air system. In the exemplary embodiment, fuel nozzle assembly 118 is coupled to atomizing air source 140 via an atomizing air manifold 143 and via atomizing air connection 144. Atomizing air manifold 143 includes a plurality of pressure and flow control devices 145 such as, but not limited to, flow control valves, check valves, isolation valves, and electronic control system interfaces (neither shown).

Further, in the exemplary embodiment, fuel nozzle assembly 118 includes a fuel nozzle body 146 that includes an atomizing air channel assembly 148. Alternatively, atomizing air channel assembly 148 is positioned within each combustor 116. Channel assembly 148 atomizes a mixture channeled therethrough to facilitate mixing fuel and air within combustor 116.

In the exemplary embodiment, additive injection system 200 includes an additive-water mixture source 202 that receives water 204 from a water source (not shown) and a water-soluble additive 208 from a water-soluble additive source 206. In the exemplary embodiment, any water-soluble additive may be used, such as, but not limited to, smoke-reducing additives and/or vanadium inhibiting additives. Additive injection system 200 also includes an additive-water mixture manifold 210 that is coupled in flow communication with fuel nozzle assembly 118 via atomizing air manifold 143 and via atomizing air connection 144. Alternatively, additive-water mixture manifold 210 is coupled in flow communication directly with atomizing air connection 144. Additive-water mixture manifold 210 includes a plurality pressure and flow control devices 211 such as, but not limited to, flow control valves, check valves, isolation valves, and/or electronic control system interfaces (neither shown). In some embodiments, manifold 210 is also coupled to pressure and flow control devices 211/145 with atomizing air manifold 143. The additive-water mixture flow 212 flows from manifold 210 through atomizing air channel assembly 148 into combustor 116.

In operation, atomizing air (not shown in FIG. 2.) is channeled from air source 140 to fuel nozzle assembly 118 for use in atomizing fuel during ignition activities and/or for use in blowing down combustors 116 and fuel nozzle assembly 118 to facilitate the removal of material and/or debris buildup therein. In the exemplary embodiment, during normal operations of gas turbine engine 100, atomizing air may be isolated and water-soluble additives channeled to fuel nozzle assembly 118 for mixing with air within combustor 116. Specifically, water 204 and additive 208 are channeled into additive-water source 202 at predetermined flow values that enable a predetermined additive concentration to be obtained. Moreover, the pressures and flow rates of predetermined additive-water mixture 212 from source 202 are selected to enable predetermined pressure and flow values to be channeled into fuel nozzle assembly 118. In the exemplary embodiment, additive-water mixture manifold 210 uses pressure and flow control devices 211 to facilitate controlling pressures and flows.

Also, in the exemplary embodiment, in operation, additive-water mixture flow 212 is channeled through atomizing air channel assembly 148 to atomize the mixture to facilitate mixing between fuel and air channeled into combustor 116. During the mixing, water in the additive-water mixture is vaporized and the remaining additive is channeled from combustor 116 towards turbine section 108. If atomizing air is determined necessary by an operator, flow from system 200 is suspended and atomizing air flow is restored. Alternatively, atomizing air manifold 143 and additive-water mixture manifold 210 are operated concurrently such that atomizing air facilitates delivery of additive-water mixture 212 through fuel nozzle assembly 118 and combustors 116 into turbine section 108 (shown in FIG. 1).

Alternatively, rather than water 204 and water-soluble additive 208, additive injection system 200 is coupled in flow communication with an oil-soluble additive source 256 in a manner similar to that of water-soluble additive source 206. Also, alternatively, system 200 forms an additive flow 258 in a manner similar to that for additive flow 208. Further, alternatively, such oil-soluble additives are mixed with any solute flows 254 of any liquid solutes that facilitate attaining a desired solubility and/or concentration of such oil-soluble additives that enable operation of system 200 as described herein. Such mixing is performed in an oil-soluble additive-solute mixture source 252 that is similar to additive-water mixture source 202 in a manner similar to water 204 mixing with additive flow 208 within additive-water mixture source 202. Also, alternatively, system 200 injects oil-soluble additives 258 mixed with solute 254 through pressure and flow control devices 211 to be mixed with air from atomizing air manifold 143 and subsequently channeled into combustor 116 via fuel nozzle body 146. Further, alternatively, system 200 injects any additives in any solutions that enable operation of system 200 as described herein.

Moreover, in other alternative embodiments, additive injection system 200 may be embedded within any combustion system that uses injected substances to facilitate a combustion process including, but not limited to, oil-fired and gas-fired burners in commercial and residential boilers and furnaces.

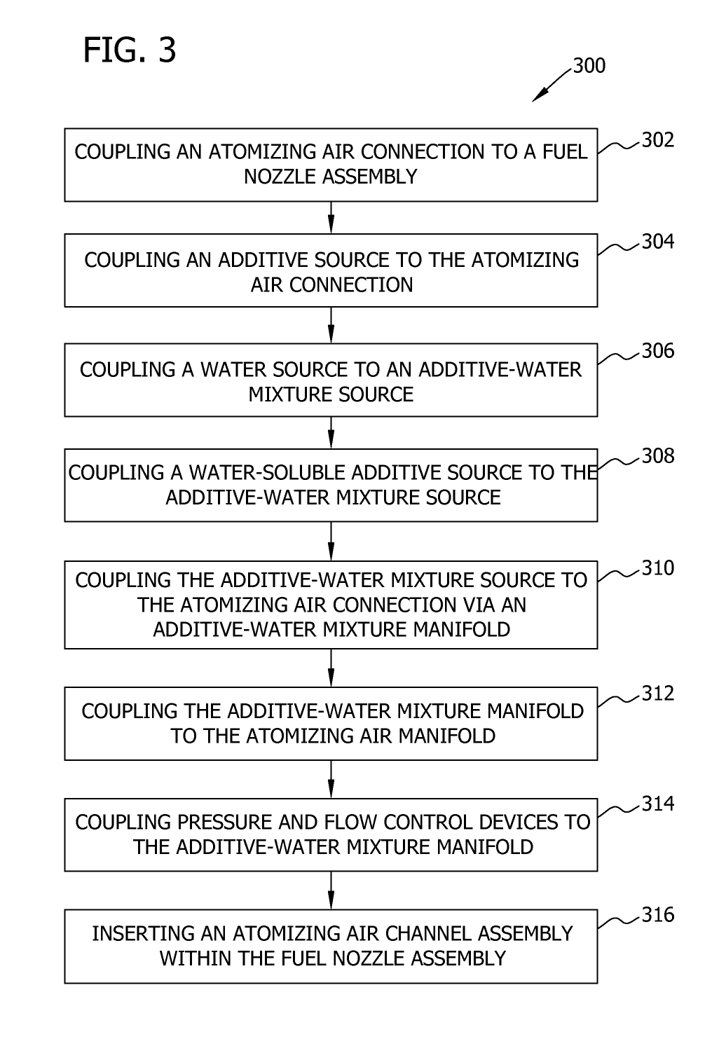

FIG. 3 is a flow chart illustrating an exemplary method 300 of assembling additive injection system 200 (shown in FIG. 2). In the exemplary embodiment, atomizing air connection 144 (shown in FIG. 2) is coupled 302 to fuel nozzle assembly 118 (shown in FIGS. 1 and 2). Additive sources 202/206 (both shown in FIG. 2) are coupled 304 to atomizing air connection 144 by coupling 306 water source 204 to additive-water mixture source 202 (both shown in FIG. 2), coupling 308 water-soluble additive source 206 (shown in FIG. 2) to additive-water mixture source 202, coupling 310 additive-water mixture source 202 to atomizing air connection 144 via additive-water mixture manifold 210 (shown in FIG. 2), and coupling 312 additive-water mixture manifold 210 to atomizing air manifold 143 (shown in FIG. 2). Moreover, pressure and flow control devices 211 (shown in FIG. 2) are coupled 314 to additive-water mixture manifold 210 and atomizing air channel assembly 148 is inserted 316 within fuel nozzle assembly 118.

Embodiments provided herein facilitate injection of additives into gas turbine engines using as much existing infrastructure as reasonable. Such additives may include inhibitors that may be injected into the combustion gas stream to inhibit deposit-induced corrosion and/or combustion byproduct formation. Using existing infrastructure to inject additives reduces use of additional hardware to control inhibitor concentration and to inject the inhibitor, thereby eliminating redundant piping systems and reducing capital construction and retrofit costs, especially in existing units wherein space is limited. Also, using existing infrastructure to inject additives reduces operational costs associated maintaining redundant piping systems.

Described herein are exemplary embodiments of methods and apparatus that facilitate injection of additives into gas turbine engines. Specifically, coupling an additive injection system to an existing atomizing air channel assembly that is coupled to a fuel nozzle assembly reduces capital construction costs. More specifically, using existing components, including sharing of existing flow and pressure control devices, reduces capital costs of materials and installation labor. Also, selecting additive concentrations that complement existing delivery infrastructure facilitates additive injection operations while eliminating redundant piping systems. Moreover, using existing delivery infrastructure facilitates reducing costs of retrofits of existing gas turbine engines and operational costs of maintaining redundant piping systems.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assembly packages and methods.

While the invention has been described in terms of various specific embodiments, those skilled in the art will recognize that the invention can be practiced with modification within the spirit and scope of the claims.

What is claimed is:

1. A method for assembling an additive injection system for use with a turbine engine, said method comprising:
coupling an atomizing air connection to a fuel nozzle assembly; and
coupling an additive source to the atomizing air connection.

2. A method in accordance with claim 1, wherein coupling an additive source to the atomizing air connection comprises at least one of:
coupling an additive-water mixture manifold to an atomizing air manifold; and
coupling the additive-water mixture manifold to the atomizing air connection.

3. A method in accordance with claim 2, wherein coupling an additive source to the atomizing air connection further comprises:
coupling a water source to an additive-water mixture source;
coupling a water-soluble additive source to the additive-water mixture source; and
coupling the additive-water mixture source to the atomizing air connection.

4. A method in accordance with claim 3, wherein coupling the additive-water mixture source to the atomizing air connection comprises coupling the additive-water mixture manifold to the additive-water mixture source and to the atomizing air connection.

5. A method in accordance with claim 4, wherein coupling the additive-water mixture manifold to the additive-water mixture source and to the atomizing air connection comprises coupling at least one of a pressure control device and a flow control device to the additive-water mixture manifold.

6. A method in accordance with claim 5, wherein coupling the additive-water mixture manifold to the additive-water mixture source and the atomizing air connection further comprises coupling an atomizing air channel assembly to the atomizing air connection.

7. A method in accordance with claim 1, wherein coupling an additive source to the atomizing air connection comprises coupling an oil-soluble additive source to the atomizing air connection.

8. An additive injection system comprising:
an atomizing air connection; and
an additive source coupled in flow communication with said atomizing air connection.

9. An additive injection system in accordance with claim 8, wherein said additive source is configured to receive a water-soluble additive.

10. An additive injection system in accordance with claim 8 further comprising at least one of:
an additive-water mixture manifold coupled to an atomizing air manifold; and
said additive-water mixture manifold coupled to said atomizing air connection.

11. An additive injection system in accordance with claim 10 further comprising:
a water source coupled to an additive-water mixture source; and
said additive source coupled to said additive-water mixture source.

12. An additive injection system in accordance with claim 11 further comprising said additive-water mixture source coupled to said atomizing air connection via said additive-water mixture manifold.

13. An additive injection system in accordance with claim 12 wherein said additive-water mixture manifold comprises at least one of a pressure control device and a flow control device.

14. An additive injection system in accordance with claim 8, wherein said additive source coupled in flow communication with said atomizing air connection comprises an oil-soluble additive source coupled in flow communication with said atomizing air connection.

15. A turbine engine comprising:
at least one combustor;
at least one fuel nozzle assembly coupled in flow communication with said at least one combustor;
an atomizing air connection coupled to said at least one fuel nozzle assembly; and
an additive source coupled in flow communication with said atomizing air connection.

16. A turbine engine in accordance with claim 15 further comprising at least one of:
an additive-water mixture manifold coupled to an atomizing air manifold; and
said additive-water mixture manifold coupled to said atomizing air connection.

17. A turbine engine in accordance with claim 16 further comprising:
a water source coupled to an additive-water mixture source; and
said additive source coupled to said additive-water mixture source.

18. A turbine engine in accordance with claim 17 further comprising said additive-water mixture source coupled to said atomizing air connection via said additive-water mixture manifold.

19. A turbine engine in accordance with claim 18 wherein said additive-water mixture manifold comprises at least one of a pressure control device and a flow control device.

20. A turbine engine in accordance with claim 15. wherein said additive source coupled in flow communication with said atomizing air connection comprises an oil-soluble additive source coupled in flow communication with said atomizing air connection.
